(19) United States
(12) Patent Application Publication
(10) Pub. No.: US 2017/0334510 A1
(43) Pub. Date: Nov. 23, 2017

(54) TRACK RACING BIKE

(71) Applicant: Felt Racing, LLC, Irvine, CA (US)

(72) Inventors: Anton A. Petrov, Irvine, CA (US); Jeffrey A. Soucek, Irvine, CA (US)

(21) Appl. No.: 15/595,321

(22) Filed: May 15, 2017

Related U.S. Application Data
(60) Provisional application No. 62/338,293, filed on May 18, 2016.

(51) Int. Cl. B62M 1/36; B62J 13/02; B62J 13/04; B62K 19/30; B62M 1/10; B62M 1/38; B62J 13/00

(52) U.S. Cl. CPC B62M 1/36; B62K 19/30; B62J 13/02; B62M 1/10; B62J 13/04; B62J 13/00; B62M 1/38

(57) ABSTRACT

A track racing bicycle having a head tube and/or down tube with asymmetrical left and right sides. A left side of the head tube and/or down tube may be closer to a central plane of a frame of the track racing bicycle for aerodynamic purposes. Moreover, the drivetrain may be disposed on the left side of the frame instead of the right side. Also, a rear wheel of the track racing bicycle may have a mechanism for mitigating or prohibiting forward slip of the rear wheel in the rear dropouts.

### CROSS-REFERENCE TO RELATED APPLICATIONS

This application claims the benefit to Provisional Patent Application No. 62/338,293 filed May 18, 2016, the entire contents of which are incorporated herein by reference.

### STATEMENT RE: FEDERALLY SPONSORED RESEARCH/DEVELOPMENT

Not Applicable

### BACKGROUND

A velodrome racing bicycle is disclosed herein. A velodrome racing event features two 180° circular bends connected by two straight paths. The circular bends are steeply bent. Cyclists ride around the velodrome track in a counterclockwise direction.

Improvements in the sport of velodrome racing are needed.

### BRIEF SUMMARY

A track racing bicycle for velodrome racing is disclosed herein. The track racing bicycle may have various features that optimize aerodynamics of the track racing bicycle in the context of velodrome racing. By way of example and not limitation, the track racing bicycle may have one or more of the following features in combination with each other or individually. The track racing bicycle may have a head tube and a down tube. The cross-section of the head tube and/or the down tube may have left and right sides which are asymmetrical with respect to each other. More particularly, the left side of the head tube and/or down tube may be closer to the centerline of the frame of the bicycle. Additionally, a chain ring and sprocket of the track racing bicycle may be disposed on a left side of a frame of the track racing bicycle. The chain ring may also have a shield or fairing which may be smooth and curved and have a dome shape in order to increase aerodynamics of the peddling area. Additionally, the rear chain stays and rear seat stays may closely follow the contour of a rear wheel the track racing bicycle. Additionally, a mechanism for mitigating slip of the rear wheel of the left and right rear dropouts which if slippage did occur would loosen up the chain may be incorporated into the left and right rear dropouts of the track racing bicycle.

More particularly, a velodrome track racing bicycle is disclosed. The bicycle may comprise front and rear wheels; a front fork with the front wheel mounted to the front fork; left and right pedals; a single chain ring mounted to a bottom bracket of a frame, the left and right pedals attached to the chain ring; a single sprocket attached to the rear wheel; a chain attached to the single chain ring and the single sprocket; the frame with the front fork, rear wheel, left pedal and right pedal mounted to the frame. The frame may further comprise at least one of a head tube and down tube of the frame of the bicycle having an asymmetrical transverse horizontal cross-section.

A left side of the at least one of the head tube and down tube may be closer to a forward direction centerline compared to a right side of the at least one of the head tube and down tube. The forward direction centerline may be a plane defined by a rotational axis of the head tube and a lateral plane of symmetry of the rear wheel. The forward direction centerline may be a plane defined by a leading edge and a trailing edge of the at least one of the head tube and the down tube.

At least 50 percent of the left side of the at least one of the head tube and down tube may be closer to the forward direction centerline compared to the right side of the at least one of the head tube and down tube.

In another aspect, a velodrome track racing bicycle is disclosed. The bicycle may comprise front and rear wheels; a front fork with the front wheel mounted to the front fork; left and right pedals; a frame with the front fork, rear wheel, left pedal and right pedal mounted to the frame, the left and right pedals disposed on left and right sides of the frame; a single chain ring disposed on a left side of a bottom bracket; a shield disposed over the chain ring; a single sprocket attached to the rear wheel on a left side of the rear wheel; a bicycle chain disposed on the left side of the frame and mounted to the chain ring and the sprocket.

The shield may be an integrated part with the single chain ring or may be a separate part wherein the single chain ring and the separate part are bolted or screwed together. The shield may have a smooth dome shaped exterior surface on the left side of the shield when the shield is attached to the bicycle.

The frame may further comprise left rear stay and left chain stay. The interior surfaces of the left rear and chain stays may be at a constant distance from a contour of a left side of the rear wheel.

The interior surface of the left rear and chain stays may be at the constant distance from the contour of the left side of the rear wheel for more than 50% of a radius of the rear wheel.

The interior surface of the left rear and chain stays may be at the constant distance from the contour of the left side of the rear wheel for more than 80% of a radius of the rear wheel.

In another aspect, a velodrome track racing bicycle is disclosed. The bicycle may comprise front and rear wheels; a front fork with the front wheel mounted to the front fork; left and right pedals; a single chain ring mounted to a bottom bracket of a frame, the left and right pedals attached to the single chain ring; a single sprocket attached to the rear wheel; a chain attached to the single chain ring and the single sprocket; the frame with the front fork, rear wheel, left pedal and right pedal mounted to the frame. The frame may further comprise left and right rear drop outs attached to at least one of rear chain stays and rear stays, each of the left and right rear drop outs having a slot for receiving an axle of the rear wheel and defining an interior surface and an exterior surface, at least one of the exterior surfaces of the left and right rear drop outs having a positive skew angle with respect to a forward direction of the bicycle.

The other one of the at least one of the exterior surfaces of the left and right rear drop outs may have a positive skew angle with respect to the forward direction of the bicycle. The other one of the at least one of the exterior surfaces of the left and right rear drop outs may be parallel to the forward direction of the bicycle.

The positive skew angle may be between 0.5 degrees and 6 degrees.

The velodrome track racing bicycle may further comprise a washer having a skew angle equal to the positive skew angle of the at least one of the exterior surfaces of the left and right rear drop outs.

The interior and exterior surfaces of the at least one of the left and right rear drop outs may have an enlarging thickness.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a velodrome track wherein cyclists ride around the track in a counterclockwise direction;

FIG. 2 is a perspective view of a bicycle aerodynamically optimized for cycling around the velodrome track;

FIG. 3 is a top view of the bicycle shown in FIG. 2;

FIG. 4 is a left side view of the bicycle shown in FIG. 2;

FIG. 5 is a transverse horizontal cross-sectional view of a head tube area at a first vertical position of the bicycle shown in FIG. 2;

FIG. 6 illustrates the view shown in FIG. 5 with a left profile shown as a dashed line to illustrate symmetry between left and right profiles whereas a solid left line illustrates asymmetry between left and right profiles;

FIG. 7 is a transverse horizontal cross-sectional view of the head tube area at a second vertical position of the bicycle shown in FIG. 2;

FIG. 8 illustrates the view shown in FIG. 7 with a left profile shown in a dashed line to illustrate symmetry between left and right profiles whereas a solid left line illustrates asymmetry between left and right profiles;

FIG. 9 is a transverse horizontal cross-sectional view of a down tube of the bicycle shown in FIG. 2;

FIG. 10 illustrates the view shown in FIG. 9 with a left profile shown in a dashed line to illustrate symmetry between left and right profiles whereas a solid left line illustrates asymmetry between left and right profiles;

FIG. 11 illustrates a top view of a rear wheel of the bicycle;

FIG. 12 illustrates a top view of an interconnection between the rear wheel and rear dropouts for mounting the rear wheel to the rear dropouts;

FIG. 13 illustrates a perspective view of a left rear dropout;

FIG. 14 illustrates a cross-sectional view of the left rear dropout; and

FIG. 15 illustrates a cross-sectional view of the right rear dropout

### DETAILED DESCRIPTION

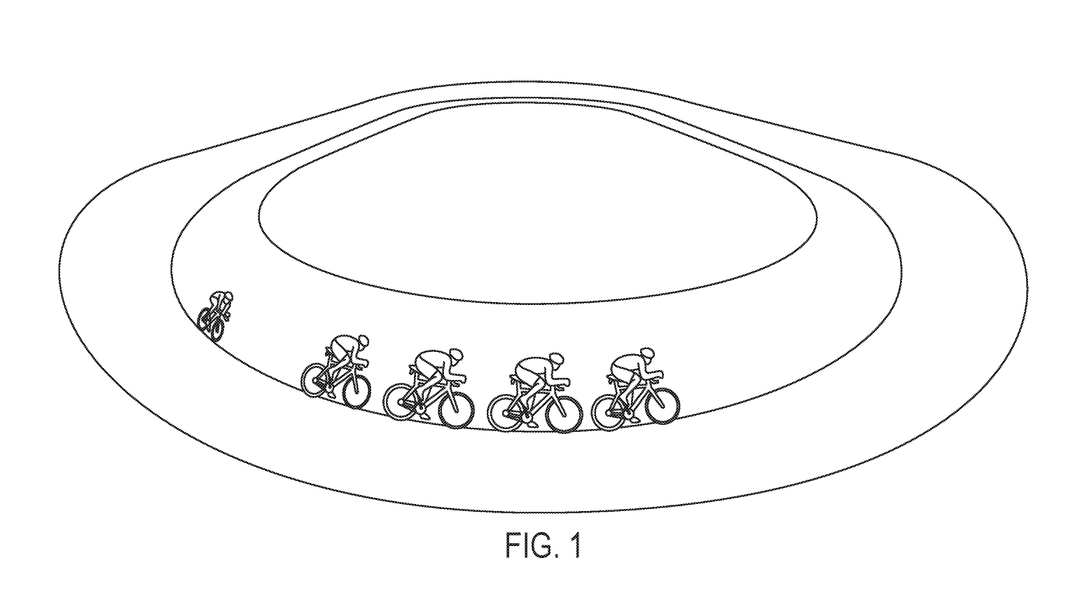

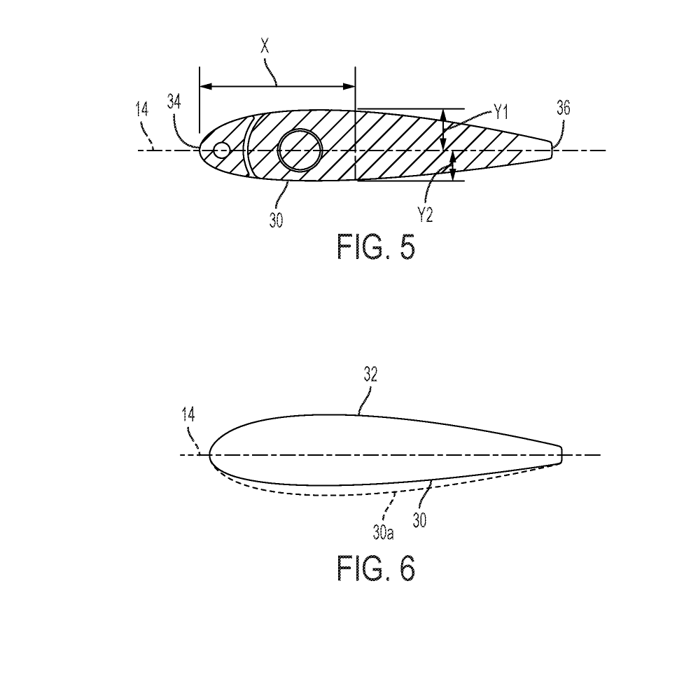

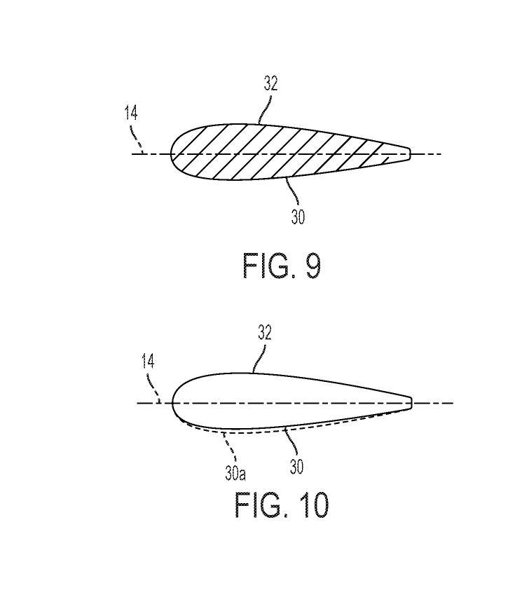

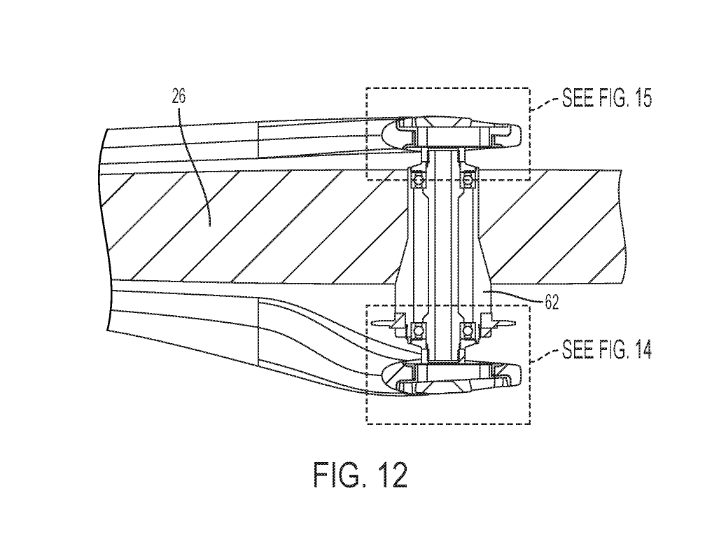

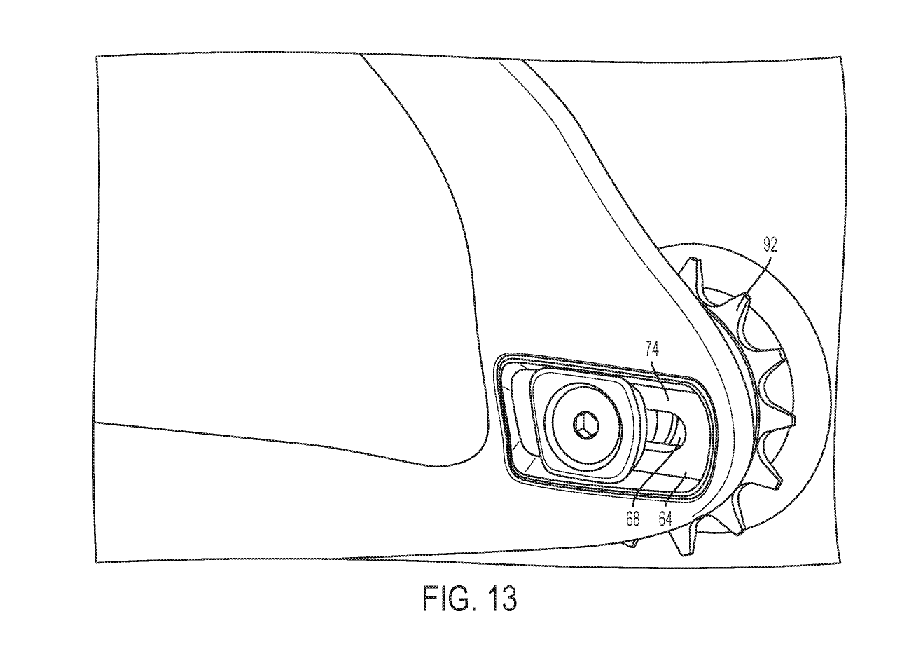

Referring now to the drawings, a bicycle 10 dedicated for velodrome racing as shown in FIG. 1 is disclosed. The bicycle 10 may have a number of features which optimize the bicycle 10 specifically for velodrome racing. In particular, the head tube area 12 may have a cross-sectional profile as shown in FIGS. 5-8 which is asymmetrical about a forward direction centerline 14 with respect to a transverse horizontal plane when the bicycle 10 is vertically upright. Additionally, the down tube 16 may also have a cross-sectional profile as shown in FIGS. 9 and 10 which is asymmetrical with respect to the forward direction centerline 14 about a transverse horizontal plane when the bicycle 10 is vertically upright. Additionally, the chain ring 18 may be disposed on a left side of the frame 20 of the bicycle 10. The chain ring 18 may also be integrally formed with the shield 22 so that the chain ring 18 and the shield 14 are fabricated from unitary material. The outer surface of the shield may have a lenticular outer shape symmetrical about a rotating axis of the chain ring. Alternatively, in certain embodiments, the shield 22 may be a separate part and placed over the chain ring 22 and a crank arm 24. In this regard, the chain ring 18 and the shield 14 may be separate parts that are secured to each other with bolts or screws. In either variant, as the bicycle 10 is turning left around the velodrome race track, these areas 12, 16, 18, 22 of the bicycle 10 are more aerodynamic as the air approaches the bicycle 10 at an angle when the bicycle makes the left turn around the velodrome track compared to a traditional symmetrical bicycle with its chain ring located on the right side of the bicycle. Moreover, a rear wheel 26 is attached to the rear dropouts with a wedge system, as shown in FIGS. 12-15, to mitigate any forward slippage of the rear wheel at a standing start of the velodrome race.

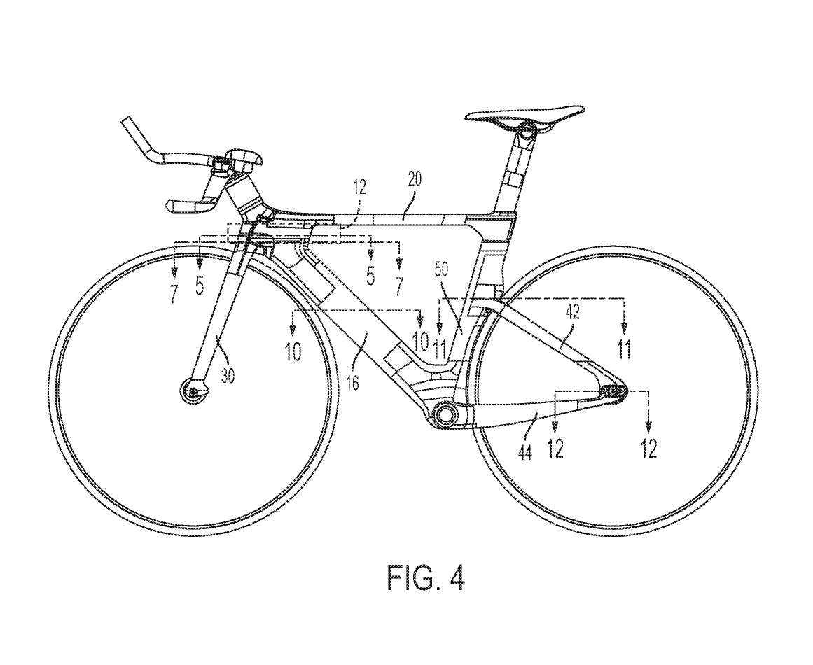

Referring now to FIGS. 4-8, the head tube area 12 and its horizontal transverse cross-sectional profile is shown. The transverse cross-sectional profile is a cross-section of the bicycle when the bicycle is vertically upright. The the cross-section is taken horizontal or parallel to the ground when the frame of the bicycle is perfectly upright. The fork 30 may be mounted to the frame 20 as discussed in U.S. patent application Ser. No. 12/510,071, the entire contents of which is incorporated herein by reference. Although the figures and embodiments disclosed herein attach the fork 30 to the frame 20 as discussed in the U.S. patent application Ser. No. 12/510,071, other attachment mechanisms may also be used. For example, traditional means of attaching forks to a head tube may be utilized as long as the head tube area is designed with left and right asymmetrical profiles as discussed herein.

Referring now to FIG. 5, with the bicycle 10 in an upright position or perpendicular to the ground and the bicycle moving straight forward meaning that the fork and handlebars are aligned straight forward, left and right profiles of a transverse cross-section of the head tube area 12 is asymmetrical with respect to the forward direction centerline 14. The forward direction centerline 14 may be defined in a variety of ways. By way of example and not limitation, the forward direction centerline 14 may be defined by a leading edge and trailing edge of the head tube and/or the down tube. Alternatively, the forward direction centerline 14 may be a plane that coincides or is in the same plane as a rotational axis of a front steering handle bar of the track racing bicycle and a lateral plane 25 of symmetry of the rear wheel 26. The rear wheel 26 may have a tire and a rim which rotates about a rear axle when the track racing bicycle moves forward. The left and right sides of the tire and rim being symmetrical may define the lateral plane 25 of the rear wheel 26. In general, the forward direction centerline 14 is generally where a rider is centrally located on the track racing bicycle. The head tube area 12 has a transverse horizontal cross-sectional profile that is aerodynamic both when the bicycle is moving forward and when the bicycle is turning left. To this end, the profile on the left side of the forward direction centerline 14 is not identical to the profile on the right side of the forward direction centerline 14. The left and right profiles 30, 32 are asymmetrical. The cross-section shown in FIGS. 5 and 6 is about mid height on the head tube area 12.

More particularly, starting from a leading edge 34 and working backwards to a trailing edge, a position on the left and right profiles 30, 32 by distance X may be located. A distance Y1 and Y2 at position X may be defined as the distance from the forward direction centerline perpendicular to the right and left profiles. Y1 and Y2 are measured at distance X perpendicular from the forward direction centerline 14 to the profiles 30, 32. In this regard, Y2 may always be less than Y1 along the length of the head tube area 12. The entire length of the head tube area 12 need not be configured so that Y2 is always less than Y1. However, it is preferred that at least a mid 50% of the entire length of the head tube area 12 be configured so that Y2 is always less than Y1. Preferably, the mid 50% of the entire length of the head tube area 12 is defined by the front and rear 25% from a midpoint between the leading edge 34 and a trailing edge 36 of the head tube area 12 along the centerline 14.

Referring now to FIG. 6, the left profile 30 which is asymmetrical to the right profile 32 is shown in phantom lines. As shown, the left profile 30 is always or a predominant portion thereof is closer to the forward direction centerline 14.

The left and right profiles may have identical contours except that the left profile is generally closer to the centerline 14 compared to the right profile 32 at any distance X as discussed above. Moreover, the left and right profiles maybe curvilinear in that the profiles 30, 32 do not have any sharp corners that might cause turbulence or increased coefficient of friction or drag.

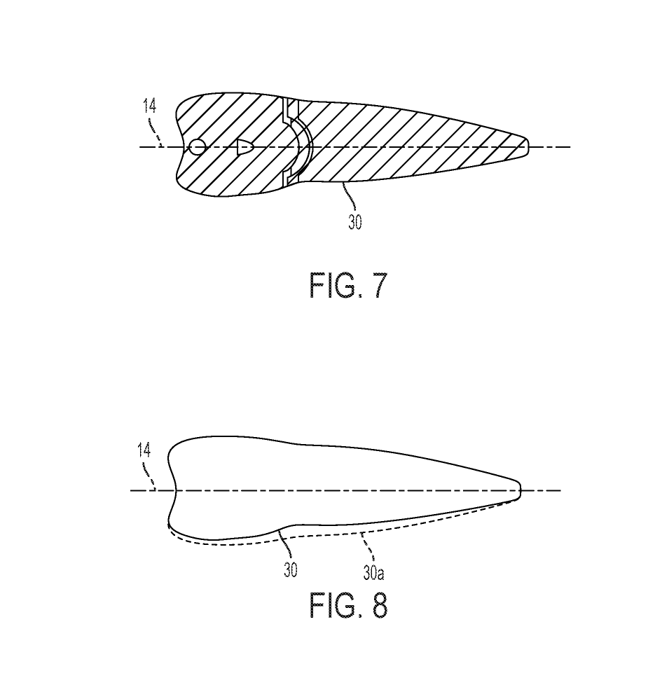

Referring now to FIGS. 7 and 8, a different cross-section along the height of the head tube area 12 is shown. The cross-section shown in FIGS. 7 and 8 is taken near a bottom area of the head tube area 12. Similar to the cross-section shown in FIGS. 5 and 6, the left profile 30 may be closer to the forward direction centerline 14 compared to the right profile 32 at any point X or at least along at least 50% of a mid portion of the head tube area 12.

Referring now to FIGS. 9 and 10, a horizontal transverse cross-section of the downtube 16 is shown when the bicycle 10 is upright and perpendicular to the ground. The horizontal transverse cross-section is typically taken when the bicycle is perfectly upright and perpendicular to the ground. The transverse cross-section is a horizontal cross-section of a frame of the bicycle when the bicycle is in that upright and perpendicular to the ground position. However, the horizontal transverse cross-section may also represent a cross-section of the bicycle frame as the bicycle is tilted to one side (e.g. left side) representing the bicycle when it is turning around the velodrome racetrack. The cross-section of the bicycle frame being horizontal to the ground. Once again, the left profile 30 may be closer to the forward direction centerline 14 compared to the right profile 32 along at least 50% of a mid portion of the down tube's or head tube's centerline 14.

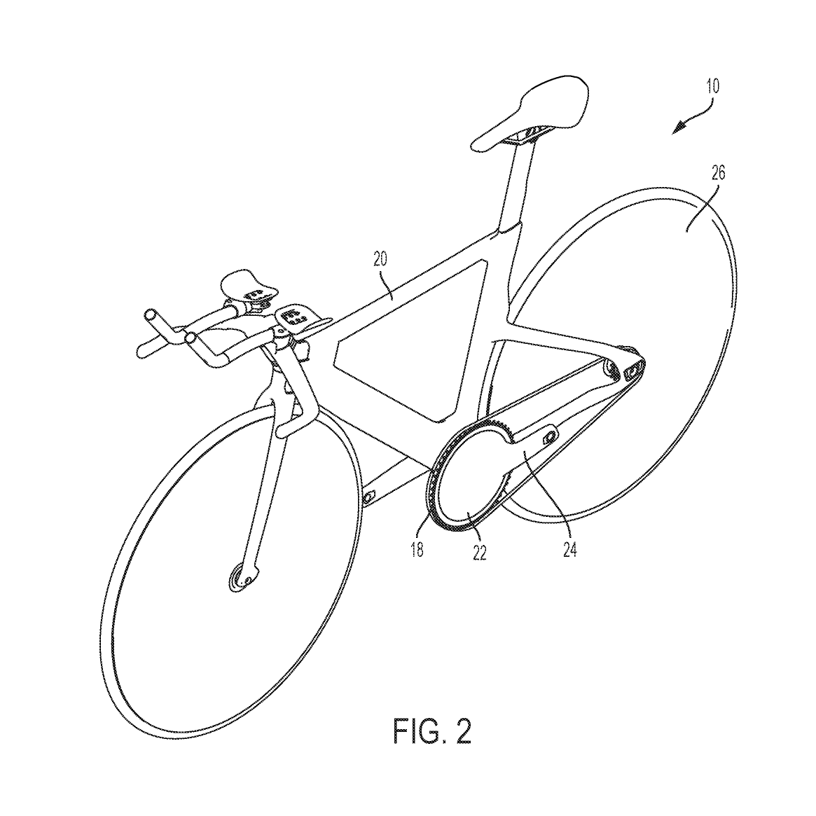

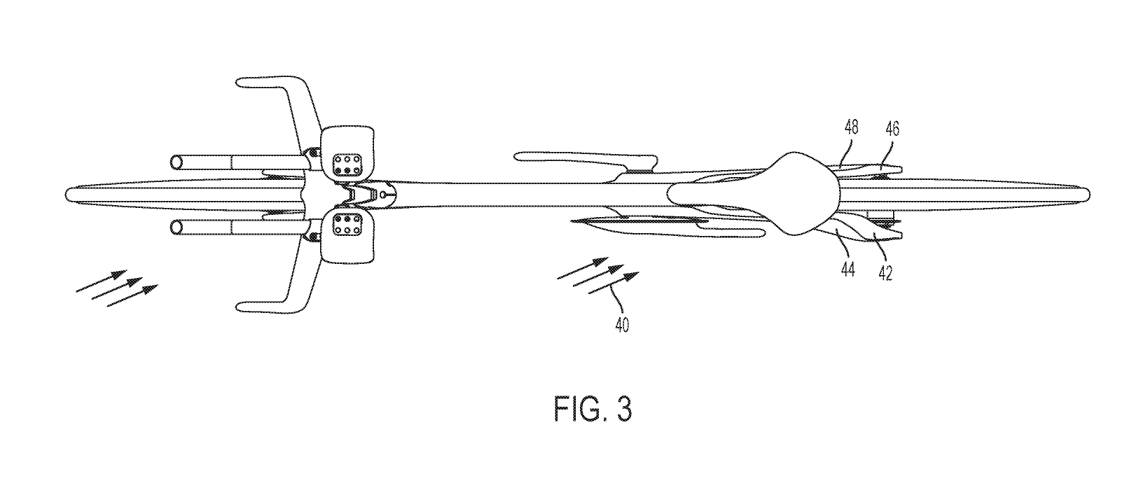

Referring now to FIGS. 2 and 3, the drivetrain of the bicycle 10 is disposed on a left side of the bicycle frame 20 instead of as is traditionally done on a right side of the bicycle frame 20. By placing the drivetrain of the bicycle 10 on the left side of the bicycle frame 20, the chain ring maybe covered with a fairing 22 that helps to smoothly divert air over the drivetrain as the air approaches the chain ring 18 and the fairing 22 at an angle shown by airflow lines 40 in FIG. 3 as the bicycle makes a left turn around the velodrome track. The fairing 22 may be smooth, curved without any sharp points.

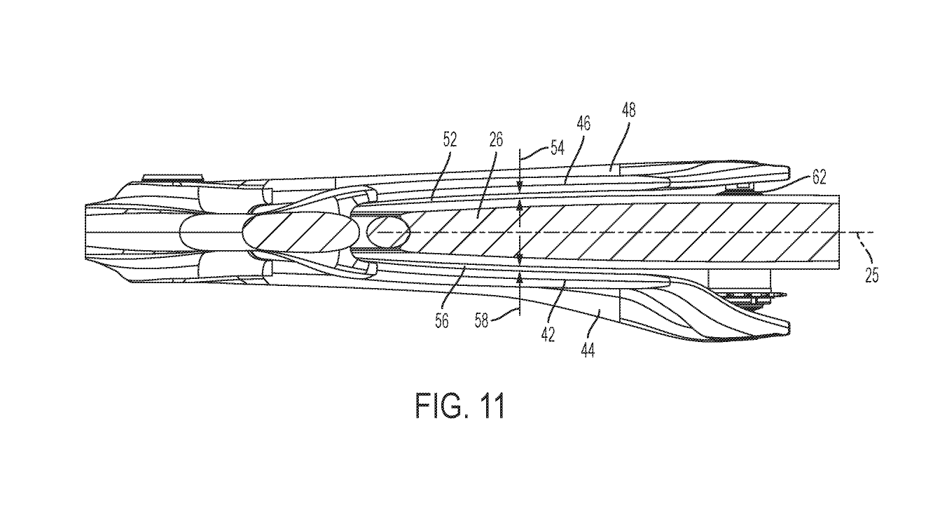

Referring now to FIG. 11, the left rear and chain stays 42, 44 and the right rear and chain stays 46, 48 both extend backward from the seat tube 50 in close conformity to left and right profiles of the rear wheel 26, as shown in FIG. 3. This maximizes aerodynamic characteristics of the frame. Right rear stay 46 and the right chain stay 48 may follow the contour of the right side of the rear wheel 26 so that a gap 52 between the interior surface of the right rear and chain stays 46, 48 may be at a generally constant distance 54 for more than 50% of the radius of the rear wheel 26. Preferably, the distance 54 stays generally constant for more than 80% of the radius of the rear wheel 26. The term generally constant 54 means that the distance is within plus or minus ⅛ of an inch along the length of the right rear and chain stays 46, 48.

Likewise, the left rear stay 42 and the left chain stay 44 may follow the contour of the left side of the rear wheel 26 so that a gap 56 between the interior surface of the left rear and chain stays 42, 44 may be at a generally constant distance 58 for more than 50% of the radius of the rear wheel 26. Preferably, the distance 58 stays generally constant for more than 80% of the radius of the real wheel 26. Moreover, the distances 54, 58 are within ⅛ of an inch to each other.

Since the powertrain is on the left side of the bicycle frame 20, the left rear and chain stays 42, 44 of the rear wheel 26 follow a left side of the rear wheel for as long as possible until it is required to extend outward since the rear sprocket 60 extends out to the left. The rear portions of the right rear and chain stays 46, 48 are asymmetrical with respect to the rear portions of the left rear and chain stays 42, 44 for aerodynamic purposes.

Referring now to FIGS. 12-15, a mechanism for attaching the rear wheel 26 to the rear dropouts of the bicycle frame 20 while mitigating forward slip of the rear wheel 26 during a standing start of the velodrome racing event is disclosed. In particular, the left and right rear dropouts 64, 66 are co-molded over by the left and right rear and chain stays 42, 44, 46, 48 at where the chain stays 44, 48 are co-joined with the rear stays 42, 46. The left and right dropouts 64, 66 have horizontal slots 68 which allow the hub 62 of the rear wheel 26 to be position anywhere along the length of the slot 68 the length of the slot 68 is aligned so as to be parallel to the ground.

Each of the left and right dropouts 64, 66 are formed from two parts. The first part 70 faces exteriorly, whereas the second part 72 faces interiorly toward the hub 62. The first and second parts 70, 72 slide over one another and are attached to each other either by being co-molded over by the frame 20 or with an adhesive.

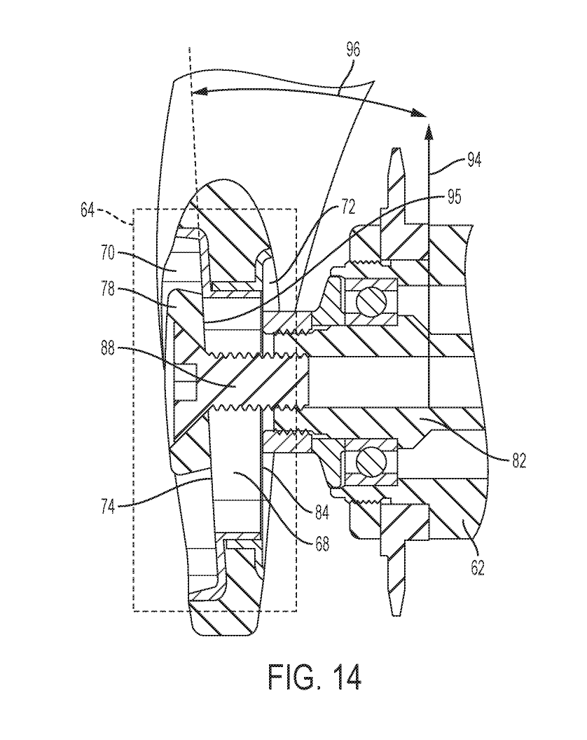

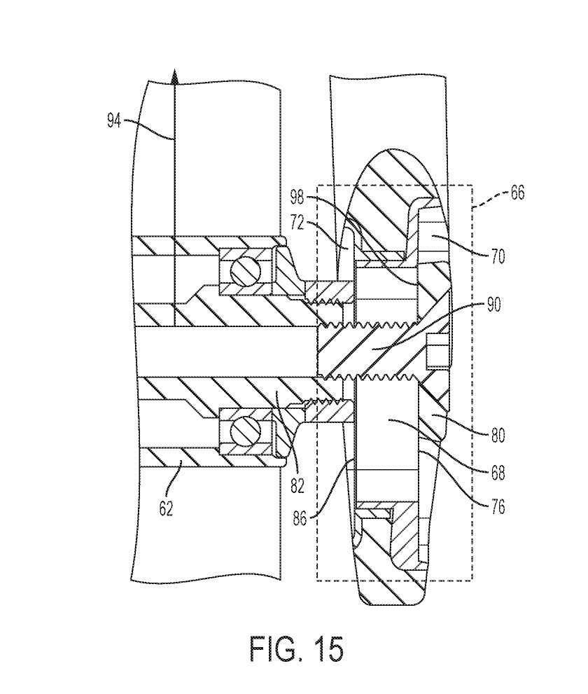

Each of the left and right dropouts 64, 66 have bearing surfaces 74, 76 which receive washers 78, 80 that can slide on the bearing surfaces 74, 76. To install the rear wheel on the rear dropouts 64, 66, the axle 82 is placed between the left and right dropouts 64, 66. The left and right dropouts 64, 66 have interior bearing surfaces 84, 86 which receive the opposed ends of the axle 82. With the axle 82 aligned to the slots 68 of the left and right dropouts 64, 66, screws 88, 90 are inserted into an aperture of the washers 78, 80 and threaded onto the opposed ends of the axle 82 as shown in FIGS. 14 and 15. The rear wheel 26 is pulled rearwardly to tension the chain disposed about a sprocket 92 of the rear wheel and the chain ring 18 until proper tension is placed on the chain. When proper tension is placed on the chain, the screws 88, 90 are tightened to lock the rear wheel 26 in place.

The first parts 70 of the left and right dropouts 64, 66 are not identical but may be identical. In the first part 70 of the left dropout 64, the bearing surface 74 is flat but has a skewed angle with respect to a forward direction 94. Preferably a skew angle 96 is between 0.5° and 6°, more preferably between 2° to 4°. Most preferably, the skew angle 96 is 3°. In contrast, in the first part 70 of the right dropout 66, the bearing surface 74 is flat and is formed to be parallel with respect to the forward direction 94 of the bicycle 10.

Moreover, the left and right washers 78, 80 are not identical, but may be identical. The left washer 78 has a bottom surface 95 that matches the skew angle 96 of the bearing surface 84 of the left dropout 64. In contrast, the right washer 80 also has a bottom surface 98 which is parallel with respect to the forward direction 94 of the bicycle 10 and does not have a skew angle so as to match the bearing surface 76 of the right dropout 66.

Because of the skew angle 96 in the left dropout, the rear wheel 26, and more particularly a left side of the rear wheel 26 does not slip forward when a significant amount of tension is placed in the chain such as at a standing start of the velodrome racing event. Constant tension is placed in the chain of the bicycle 10 during the racing event so that any vibration that may cause the left side of the axle 82 to slip backwards is prevented. The skew angle or wedging effect prevents any forward slip caused by tension in the chain by applying a forward force applied to the left side of the axle.

The bearing surface 76 of the right rear dropout 66 is parallel to the forward direction 94. Preferably, the bearing surface 74 of the left dropout 64 is at a skewed angle as shown in FIG. 14 but the bearing surface 76 of the right dropout 66 is parallel to the forward direction 94. This is to mitigate any rearward slip of the right side of the axle 82 from the right rear drop out.

In relation to the dropouts 64, 66, the drawings and description provided above explained that the bearing surface 74 of the left dropout 64 is at a skew angle with respect to the forward direction 94 and that the bearing surface 76 of the right dropout 66 is parallel with the forward direction 94. The forward direction 94 represents a line defined by forward movement of the bicycle without any turning to the left or right. The forward direction 94 is parallel with a central plane of the bicycle frame. The central plane of the bicycle frame may be a plane that is defined by a rotational axis of the steering handle bar of the bicycle and the central axis of a seat tube or vertical midplane of the seat of the track racing bicycle. Moreover, the skew angle 96 shown in FIG. 14 is a positive skew angle in that once the screw 88 is tightened on to the axle 82, forward movement of the actual 82 on the left side is prevented due to the enlarging thickness of the dropout 64 defined by the bearing surfaces 74, 84. However, it is also contemplated that both bearing surfaces 74, 76 of the left and right dropouts 64, 66 may be at a positive skew angle with respect to the forward direction 94. In relation to the right dropout, a positive skew angle means that the right dropout 66 has an enlarging thickness defined by the bearing surfaces 76, 86 while bearing service 86 is parallel to the forward direction 94. As a further alternative, is also contemplated that the bearing surface 74 of the left dropout may be parallel with the forward direction 94 whereas the bearing surface 76 of the right dropout 66 may have a positive skew angle.

The above description is given by way of example, and not limitation. Given the above disclosure, one skilled in the art could devise variations that are within the scope and spirit of the invention disclosed herein, including various ways of configuring the shield over the chain ring. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A velodrome track racing bicycle comprising:
front and rear wheels;
a front fork with the front wheel mounted to the front fork;
left and right pedals;
a single chain ring mounted to a bottom bracket of a frame, the left and right pedals attached to the chain ring;
a single sprocket attached to the rear wheel;
a chain attached to the single chain ring and the single sprocket;
the frame with the front fork, rear wheel, left pedal and right pedal mounted to the frame, the frame further comprising:
at least one of a head tube and down tube of the frame of the bicycle having an asymmetrical transverse horizontal cross-section.

2. The track racing bicycle of claim 1 wherein a left side of the at least one of the head tube and down tube is closer to a forward direction centerline compared to a right side of the at least one of the head tube and down tube.

3. The track racing bicycle of claim 2 wherein the forward direction centerline is plane defined by a rotational axis of the head tube and a lateral plane of symmetry of the rear wheel.

4. The track racing bicycle of claim 2 wherein the forward direction centerline is a plane defined by a leading edge and a trailing edge of the at least one of the head tube and the down tube.

5. The track racing bicycle of claim 2 wherein at least 50 percent of the left side of the at least one of the head tube and down tube is closer to the forward direction centerline compared to the right side of the at least one of the head tube and down tube.

6. A velodrome track racing bicycle comprising:
front and rear wheels;
a front fork with the front wheel mounted to the front fork;
left and right pedals;
a frame with the front fork, rear wheel, left pedal and right pedal mounted to the frame, the left and right pedals disposed on left and right sides of the frame;
a single chain ring disposed on a left side of a bottom bracket;
a shield disposed over the chain ring;
a single sprocket attached to the rear wheel on a left side of the rear wheel;
a bicycle chain disposed on the left side of the frame and mounted to the chain ring and the sprocket.

7. The velodrome track racing bicycle of claim 6 wherein the shield is an integrated part with the single chain ring.

8. The velodrome track racing bicycle of claim 6 wherein the shield has a smooth dome shaped exterior surface on a left side of the shield.

9. The velodrome track racing bicycle of claim 6 wherein the frame further comprises left rear stay and left chain stay, interior surfaces of the left rear and chain stays being at a constant distance from a contour of a left side of the rear wheel.

10. The velodrome track racing bicycle of claim 9 wherein the interior surface of the left rear and chain stays are at the constant distance from the contour of the left side of the rear wheel for more than 50% of a radius of the rear wheel.

11. The velodrome track racing bicycle of claim 9 wherein the interior surface of the left rear and chain stays are at the constant distance from the contour of the left side of the rear wheel for more than 80% of a radius of the rear wheel.

12. A velodrome track racing bicycle comprising:
front and rear wheels;
a front fork with the front wheel mounted to the front fork;
left and right pedals;
a single chain ring mounted to a bottom bracket of a frame, the left and right pedals attached to the single chain ring;
a single sprocket attached to the rear wheel;
a chain attached to the single chain ring and the single sprocket;
the frame with the front fork, rear wheel, left pedal and right pedal mounted to the frame, the frame further comprising:
left and right rear drop outs attached to at least one of rear chain stays and rear stays, each of the left and right rear drop outs having a slot for receiving an axle of the rear wheel and defining an interior surface and an exterior surface, at least one of the exterior surfaces of the left and right rear drop outs having a positive skew angle with respect to a forward direction of the bicycle.

13. The velodrome track racing bicycle of claim 12 wherein the other one of the at least one of the exterior surfaces of the left and right rear drop outs has a positive skew angle with respect to the forward direction of the bicycle.

14. The velodrome track racing bicycle of claim 12 wherein the other one of the at least one of the exterior surfaces of the left and right rear drop outs is parallel to the forward direction of the bicycle.

15. The velodrome track racing bicycle of claim 13 wherein the positive skew angle is between 0.5 degrees and 6 degrees.

16. The velodrome track racing bicycle of claim 12 further comprising a washer having a skew angle equal to the positive skew angle of the at least one of the exterior surfaces of the left and right rear drop outs.

17. The velodrome track racing bicycle of claim 12 wherein the interior and exterior surfaces of the at least one of the left and right rear drop outs have an enlarging thickness.
